(19) United States
(12) Patent Application Publication
(10) Pub. No.: US 2008/0010239 A1
(43) Pub. Date: Jan. 10, 2008

(54) Systems and methods of managing product tracking data

(75) Inventor: Zoltán Nochta, Karlsruhe (DE)

Correspondence Address: Chad R. Walsh;Fountainhead Law Group, Suite 509, 900 Lafayette St., Santa Clara, CA, 95050, US

(73) Assignee: SAP AG, Waldorf (DE)

(21) Appl. No.: 11/483,478

(22) Filed: Jul. 10, 2006

(51) Int. Cl. G06F 17/30

(52) U.S. Cl. 707/2

(57) ABSTRACT

In one embodiment the present invention includes a method for managing tracking data for tracking products in a supply chain. The method includes the ability for the current owner of the product to authorize the next owner to access the tracking data. In this manner, the tracking system need not be pre-configured with the details of the supply chain, but may instead dynamically adjust as the supply chain changes in accordance with market conditions.

### CROSS REFERENCE TO RELATED APPLICATIONS

Not applicable.

### BACKGROUND

The present invention relates to data management systems, and in particular, to data management systems for managing product tracking data.

Today, the design, production, distribution, sales, maintenance of products and many other related business activities are conducted by multiple collaborating companies that build a so-called “supply chain”. The different entities in the supply chain use their company-specific knowledge, resources and competencies in order to fulfill consumers' requirements by producing, transporting, transforming, etc. high-quality goods and related services.

The goal of so-called “track and trace” systems (also called tracking systems) in this context is to gather information about goods during their lifecycle. In this manner, goods may be tracked at the very atomic level (that is, on an individual item level), or at any other logistics handling unit levels, such as deliveries, pallets, cases, etc.

Various types of data may be collected by track and trace systems. Such types include geographic information, environmental information, timestamp information, etc. For example, the geographic information may be information regarding the various geographic locations visited by the goods, such as the addresses of related producers, carriers, wholesalers, distributors, consumers, etc. The environmental information may be information related to temperature, such as temperature values measured during storage and transportation of tracked goods. The timestamp information may include timestamps for delivery, shipments, repair works, etc.

Depending on the collected information and the quality (that is, the accuracy and completeness) of the resulting data, tracking information can be used in different business relevant cases. Examples include sophisticated inventory management, product authentication, product recall actions due to a production failure, quality management of shipping processes, etc.

A tracking system that, for instance, tracks products of any producer in a given industry (for example, the pharmaceuticals of each pharmaceutical company) may have components such as a database, a search base (or index base), data management systems, and data query systems. The involved parties of the supply chain can connect to the system and can feed their respective data into it via respective clients.

When searching for tracking information to a given product that may be identified by an identifier (which may be unique), the user can connect to the tracking system, make a request, and download a subset of the available information related to the object in question. The identifier may include an electronic product code (EPC), a barcode, a printed or engraved serial number, etc.

In general, the tracking system is outside of the supply chain. That is, the various entities in the supply chain direct the products according to market need, and the tracking system manages the tracking information.

A number of issues arise when using many existing tracking systems. Foremost among these are the security issues. Each entity in the supply chain needs to be authorized to access and update the tracking information at the relevant time. Such authorization is complex when the supply chain adjusts according to market need. More specifically, the tracking system operator does not know which business entity will be the intended next party in the supply chain that will further manufacture, ship, store, sell, buy, etc. the given tracked object. This is rather determined by ad-hoc economic needs, incoming orders, changes on transportation routes, costs, seasonal market behavior, fashion trends, etc. As market needs shift, entities may be added to, removed from, or moved around in the supply chain.

Therefore, the operator of the tracking system has no a priori information which entities should be made capable to access (for example, read, write, alter or delete) the corresponding tracking data. In the worst case, the operator of the tracking system does not even know all the possible entities that might be the next entities at some future point of time.

Furthermore, some compartmentalization of tracking information is desirable. For example, an entity in the supply chain could potentially use the tracking system to gather business intelligence on another entity in the chain unless the tracking information is compartmentalized. The operator has to take care of a secure authorization and access control to the business sensitive tracking data.

The security issues are further complicated when the tracking system is itself outside of the supply chain. In such a case, the tracking system cannot (by itself) define the access levels to be given to the various entities in the supply chain.

Thus, there is a need for an improved tracking system. The present invention solves these and other problems by providing a tracking system that allows one entity in the supply chain to authorize another entity in the supply chain to access the tracking system.

### SUMMARY

Embodiments of the present invention improve the tracking of products in a supply chain. In one embodiment, the present invention includes a computer-implemented method of managing product tracking data for tracking products in a supply chain. The method includes authorizing access to a database by a first entity. The method further includes accessing, by the first entity, a data record in the database. The data record is associated with a product to be tracked in the supply chain. The method further includes associating, by the first entity, the data record with a second entity. The second entity corresponds to an entity in the supply chain that will assume control over the product subsequent to said first entity. The method further includes authorizing access to the database by the second entity. The method further includes accessing, by the second entity, the data record in the database.

According to another embodiment of the present invention, a computerized system implements the above method. The method may be implemented with software that is supported by databases.

In this manner, the tracking system need not be pre-configured with the details of the supply chain, but may instead dynamically adjust as the supply chain changes in accordance with market conditions.

The following detailed description and accompanying drawings provide a better understanding of the nature and advantages of the present invention.

### BRIEF DESCRIPTION OF THE DRAWINGS

FIG. 1 is a block diagram of a tracking system according to an embodiment of the present invention.

FIG. 2 is a block diagram of a process according to an embodiment of the present invention.

FIGS. 3A-3B are data definition tables relating to access records according to embodiments of the present invention.

FIGS. 3C-3E are data tables that correspond to example access records according to embodiments of the present invention.

FIG. 4A is a data definition table relating to a tracking record according to an embodiment of the present invention.

FIG. 4B is a data table that corresponds to an example tracking record according to an embodiment of the present invention.

FIG. 5 is a block diagram of a supply chain 500 through which a product is tracked according to an embodiment of the present invention.

### DETAILED DESCRIPTION

Described herein are techniques for operating a tracking system that tracks products in a supply chain. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include obvious modifications and equivalents of the features and concepts described herein.

The following description describes various methods and processes. Although the particular method steps are discussed in a particular order, such discussion is mainly for clarity of presentation. It should be recognized that such order may be varied, and some steps may be performed in parallel. One step need only follow another step when the other step must be completed before the one step begins.

In the following description, the term “access” is used. “Access” should be interpreted broadly to mean accessing data in order to read, write, create, update, modify, copy, delete, exercise control over, or otherwise manipulate the data, with particular applicability to data relating to tracking products in a supply chain. Access also broadly includes the ability to grant or to deny, wholly or partially, access to the data to others.

In the following description, the term “control” is used. “Control” should be interpreted broadly to mean the ability to exert physical influence on a product, including manufacturing, remanufacturing, refurbishing, shipping, delivering, receiving, storing, selling, buying, etc. the product, with particular applicability to the use and movement of the product in a supply chain, and the tracking of the product in the supply chain. Control also includes the ability to incorporate the tracked product into another product that may itself be tracked.

In the following description, the term “entity” is used. “Entity” should be interpreted broadly to mean an individual, a group, a company, an association, a business, or other entity that exercises control over a product in a supply chain. Two or more entities make up a supply chain.

In the following description, the term “owner” is used. “Owner” should be interpreted broadly to mean an entity that is capable of exercising control over a product. Often a product may have only one owner at a given time.

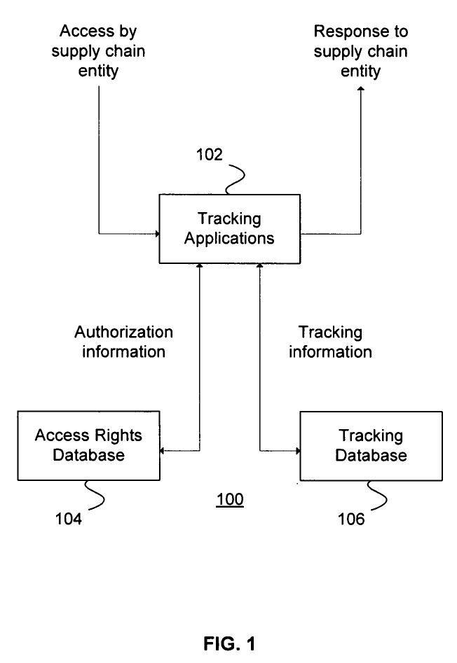

FIG. 1 is a block diagram of a tracking system 100 according to an embodiment of the present invention. The tracking system 100 may be implemented in a computer system, for example, as computer programs, data, and databases. The tracking system 100 includes one or more tracking applications 102, an access rights database 104, and a tracking database 106. The tracking system 100 may include, be a part of, or otherwise interface with other hardware or software components, which (for conciseness) are not shown.

The tracking applications 102 generally function as an interface between the entities in the supply chain and the tracking data. The tracking applications 102 receive as inputs various accesses from entities in the supply chain. For example, an entity may connect to the tracking applications 102 via a network, and may enter data as prompted by the tracking applications 102. The tracking applications 102 generate as outputs responses to the entities, which may include access to the tracking data.

The access rights database 104 generally works with the tracking applications 102 to control access to the tracking data. The access rights database 104 receives as inputs information from the tracking applications 102. This information may be in the form of queries regarding whether a particular entity is authorized to access particular tracking data. The access rights database 104 generates as outputs information back to the tracking applications 102. This information may be in the form of authorization acknowledgements that indicate whether a particular entity is authorized to access the particular tracking data that was queried. The authorization acknowledgements may also indicate what specific types of access are authorized to the entity for that particular tracking data.

The tracking database 106 generally stores the tracking data for the products to be tracked in the supply chain. The tracking database 106 receives as inputs tracking information. The tracking information may be in the form of authorized accesses to particular tracking data by a particular entity. Such authorized access may include updates to tracking data. The tracking database 106 generates as outputs the responses to the authorized accesses. Such responses may include the tracking data itself, or a portion thereof, depending upon the level of authorized access, for example, in response to a read request.

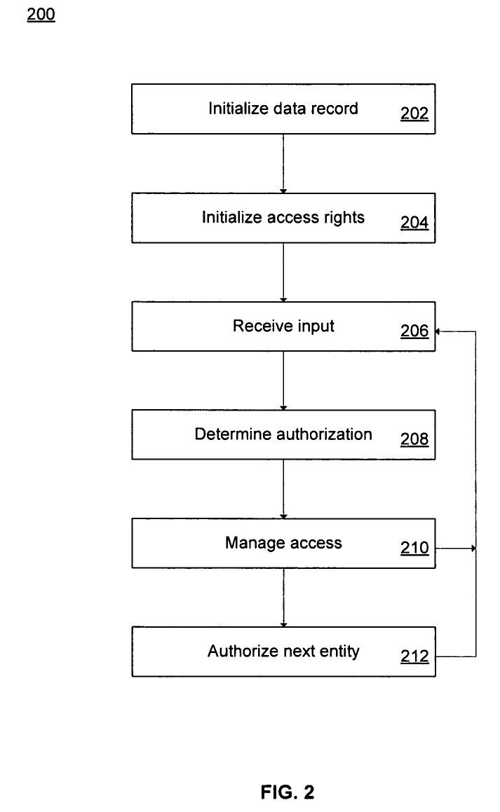

FIG. 2 is a block diagram of a process 200 according to an embodiment of the present invention. The process 200 may be implemented on the computer system that implements the tracking system 100. In such case, the process 200 may be performed by the tracking applications 102 or by other applications. Steps 202-204 concern initialization of the tracking data in the process 200, and steps 206-212 concern the general tracking operation in the process 200.

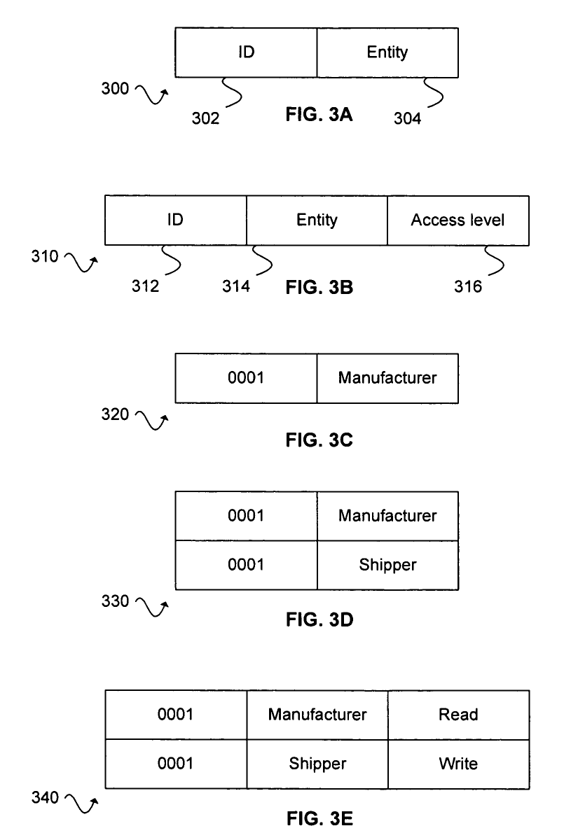

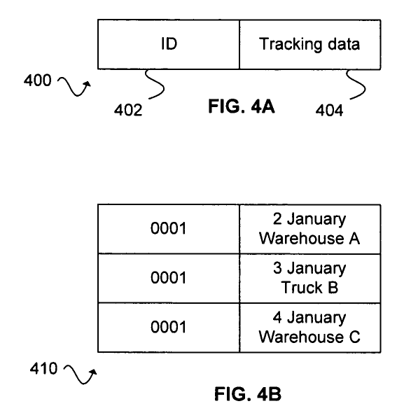

In step 202, a data record is initialized for the product to be tracked. This involves creating an access record for the product in the access rights database 104 and creating a tracking record for the product in the tracking database 106. The access record is generally a data structure that includes a unique identifier for the product to be tracked, as well as an indicator of what entities are authorized to access the tracking data for that product. (See FIGS. 3A-3E and related description below for further details regarding the access record.) The tracking record is generally a data structure that includes the unique identifier for the product to be tracked, as well as other data related to tracking the product in the supply chain. (See FIGS. 4A-4B and related description below for further details regarding the tracking record.)

In step 204, the access rights for the data record are initialized. For a given product to be tracked, one or more entities are initially authorized to access the data record. According to one embodiment, the authorized entity (or entities) is indicated in the access record. The level of the entity's authorized access may also be indicated in the access record. For example, one access level would be the ability to authorize additional entities to access the tracking record. Other levels of access include read access, write access, update access, modification access, delete access, copy access, etc.

According to one embodiment, a single entity is authorized upon initialization of the data record. This single entity is often the first entity in the supply chain, such as the manufacturer of the product to be tracked. This first entity is authorized to authorize additional entities to access the tracking record.

Once the data record has been initialized, the process 200 proceeds to the general operational mode. The general operational mode is directed mainly toward updating tracking data for a particular product as it moves in the supply chain.

In step 206, the tracking applications 102 receive an input from an entity in the supply chain. This input is often in the form of a query for access to tracking data or an update to tracking data. The input may be digitally signed or encrypted, in which case the tracking applications 102 may verify the digital signature or perform the decryption as necessary, or may interface with other applications to do so.

In step 208, the tracking applications 102 determine whether the entity enquiring in step 206 is authorized to access the tracking data. This involves accessing the access rights database 104. The relevant access record will indicate whether the entity is authorized to access a given tracking record. If the access record indicates that the entity is to be given a specific type of access (for example, read access or update access), the tracking applications 102 determine that as well from the access rights database 104.

In step 210, once the access has been authorized, the tracking applications 102 manage the access by the enquiring entity to the tracking data. In general, this involves the entity updating the tracking record for the tracked product. For example, a shipping entity may update the tracking record to include a delivery time of the product when it delivers the product to a warehouse. This may also involve providing information back to the entity, such as a response to a read request, or a verification that an update has been processed.

The process 200 may continue in steps 206-210 as various authorized entities access the tracking data as the product moves in the supply chain.

In step 212, an additional entity is authorized to access the tracking data for a given product. According to an embodiment of the present invention, an authorized entity in the supply chain may have the ability to authorize another entity to access the tracking data for a given product. Often the “current owner” of the product authorizes the prospective or anticipated “next owner” in the supply chain. In such a manner, entities may enter or leave the supply chain according to market needs, the supply chain adjusts to the changes, and the tracking system can track products in the supply chain without having any a priori knowledge of the supply chain.

For example, for a given product, the manufacturer may be initially authorized to access the tracking data. The manufacturer then accesses the tracking system 100 as desired to update the tracking data for the product. The next entity in the supply chain is the shipper, so the manufacturer authorizes the shipper to access the tracking data for the product. The shipper then accesses the tracking system 100 as desired to update the tracking data for the product. The next entity in the supply chain is the wholesaler, so the shipper authorizes the wholesaler to access the tracking data for the product. The wholesaler then accesses the tracking system 100 as desired to update the tracking data for the product. And so on.

Often, a single “next owner” is authorized at each relevant point. However, more than one “next owner” may be authorized if so desired. The multiple next owners may correspond to multiple branches in the supply chain. For example, a manufacturer may authorize two shippers as the next owners of the product. Whichever one of the two shippers that becomes the current owner then accesses the tracking data for the product. The multiple next owners may also be multiple stages in the supply chain. For example, a manufacturer may authorize a shipper as the next owner of the product, and may also authorize a wholesaler as the second next owner of the product.

The process 200 may continue in steps 206-212 as various authorized entities access the tracking data as the product moves in the supply chain.

Once the next entity has assumed control over the product and become the current owner, the access rights of the previous owner may be adjusted. For example, once the shipper has assumed control over the product from the manufacturer, the access rights of the manufacturer may be adjusted to allow read access, but not write access, to the tracking data.

In the general case for the process 200 described above, the data record is created by the first entity in the supply chain. However, other entities in the supply chain may also create data records that correspond to additional products to be tracked. For example, a first manufacturer may initiate tracking of a first product that is delivered to a second manufacturer. The second manufacturer may incorporate the first product into a second product and may create a data record for the second product. The tracking record for the first product may be updated to include a pointer to the tracking record for the second product. The tracking record for the second product may be updated to include a pointer to the tracking record for the first product.

Although the general operational mode of the process 200 is directed toward transactional access to the tracking data, the tracking applications 102 may also include features to allow aggregative access to the tracking data by authorized entities. For example, if a manufacturer is using two shipping companies, the manufacturer may be authorized to view the tracking data for completed deliveries, in order to compare the performance of the shipping companies.

FIGS. 3A-3E relate to access records used in embodiments of the present invention. FIGS. 3A-3B are data definition tables relating to access records according to embodiments of the present invention. FIGS. 3C-3E are data tables that correspond to example access records according to embodiments of the present invention.

FIG. 3A shows a data definition table 300 that includes two fields, an ID field 302 and an entity field 304. The ID field 302 stores an identifier that corresponds to the product to be tracked. The entity field 304 stores an identifier that corresponds to an authorized entity.

FIG. 3B shows a data definition table 310 that includes three fields, an ID field 312, an entity field 314, and an access level field 316. The ID field 312 and the entity field 314 correspond to the similar fields in FIG. 3A. The access level field 316 stores an identifier that corresponds to a level of access.

FIG. 3C shows a data table 320 corresponding to the data definition table 300 that includes example data. The example data shows that for the tracked product identified by identifier 0001, the manufacturer is authorized to access the tracking data.

FIG. 3D shows a data table 330 corresponding to the data definition table 300 that includes example data. The example data shows that for the tracked product identified by identifier 0001, the manufacturer and the shipper are authorized to access the tracking data.

FIG. 3E shows a data table 340 corresponding to the data definition table 310 that includes example data. The example data shows that for the tracked product identified by identifier 0001, the manufacturer has read access to the tracking data, and the shipper has write access to the tracking data. Thus, the example data indicates that the manufacturer has ceded control over the tracked product to the shipper.

As discussed above, the particular fields that are implemented in the access record may be adjusted according to design criteria. The fields shown above are for example purposes to illustrate the broad concept behind embodiments of the present invention.

FIGS. 4A-4B relate to tracking records according to embodiments of the present invention. FIG. 4A is a data definition table relating to a tracking record according to an embodiment of the present invention. FIG. 4B is a data table that corresponds to an example tracking record according to an embodiment of the present invention.

FIG. 4A shows a data definition table 400 that includes two fields, an ID field 402 and a tracking data field 404. The ID field 402 stores an identifier that corresponds to the product to be tracked. The tracking data field 404 stores tracking data.

FIG. 4B shows a data table 410 corresponding to the data definition table 400 that includes example data. The example data shows that for the tracked product identified by identifier 0001, on 1 January the tracking record was initialized, on 2 January the tracked product was in Warehouse A, on 3 January the tracked product was in Truck B, and on 4 January the tracked product was in Warehouse C.

As discussed above, the particular fields that are implemented in the tracking record may be adjusted according to design criteria. The fields shown above are for example purposes to illustrate the broad concept behind embodiments of the present invention. Example fields include a date field, a time field, a location field, a temperature field, a pointer field, a general information field, etc.

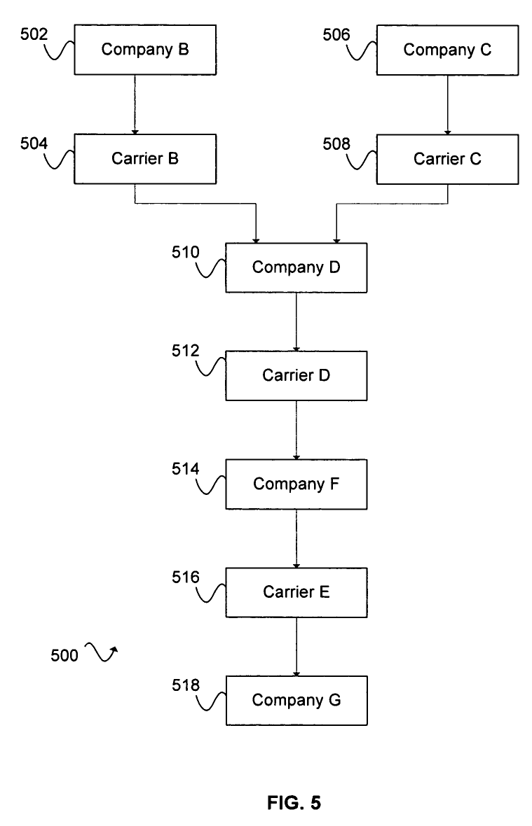

FIG. 5 is a block diagram of a supply chain 500 through which a product is tracked according to an embodiment of the present invention. The block diagram provides a visual reference for an example process to schematically demonstrate how the embodiments of the present invention work in real world scenarios.

The supply chain 500 includes Company B 502, Carrier B 504, Company C 506, Carrier C 508, Company D 510, Carrier D 512, Company F 514, Carrier E 516, and Company G 518.

Company B 502 is a vendor of nuts and Company C 506 is a manufacturer of bolts. Company D 510 integrates the nuts and the bolts into a common product referred to as a gizmo. The resulting gizmo is then distributed, sold, or used, etc. by Company F 514 and Company G 518.

Company B 502 is initially authorized to edit the respective parts of the tracking database 106 (see FIG. 1) that are foreseen to hold data on “nuts produced by Company B 502”.

When producing nuts, Company B 502 initializes the data sets (see steps 202-204 in FIG. 2). Depending on the desired granularity of the tracking data, Company B 502 can set up identifiers and the respective tracking data sets, e.g. for every single nut that it has been producing.

When getting an order from Company D 510, Company B 502 engages Carrier B 504 to deliver the requested nuts.

Thereby, Company B 502 can edit (i.e. write) the tracking data of the given nuts to state that they (e.g. represented by the identifiers) will be delivered and should arrive at Company D 510 (e.g. given by the postal address) at a certain date and time, etc., and also to state that the delivery is done by Carrier B 504.

Further, Company B 502 also updates the respective content of the access rights database 104 (see FIG. 1) by sending a digitally signed message to the tracking system 100 (see FIG. 1) expressing that the respective tracking data to the given delivered nuts now can only be edited, i.e. written by Carrier B 504 as it is the new (temporary) owner of the delivered goods.

When arriving at the targeted Company D 510, Carrier B 504 alters the tracking data, e.g., it sets the date/time of delivery, transport vehicle identifier, etc. for the delivered nuts.

In the same time, Carrier B 504 also authorizes Company D 510 to alter the respective data sets, since Company D 5 10 is the new responsible owner of the shipped goods.

Company C 506 manages its bolt delivery on Company D 510 in a similar way, by authorizing Carrier C 508 as the responsible transportation company.

When producing the added value products from nuts and bolts, Company D 510 can set up new tracking data sets and unique identifiers for the produced new items (gizmos).

These data sets can contain (backward) pointers to the respective data sets of the different built-in parts (i.e., nuts and bolts) of the new products. Alternatively, Company D 510 can decide to further edit the existing separated data sets of the nuts or the bolts without setting up new data sets.

Goods produced by Company D 510 can then be distributed and sold in a similar way on other members of the supply chain, including Carrier D 512, Company F 514, Carrier E 516, and Company G 518.

The methods and systems according to embodiments of the present invention help operators and participating entities within the supply chain (typically companies) to manage access to the possibly highly sensitive information stored in product tracking systems. For this purpose of authorization, the operator of the tracking system provides a service to which the entities within the supply chain can connect.

As mentioned above, at each point of time within a given product's lifecycle, there is a given definite set of entities (and often a single entity) that currently have control over a particular product in the supply chain at the respective point of time.

As described above, many existing tracking systems are unable to adequately manage access to the tracking data. The embodiments of the present invention solve this dilemma by allowing the relevant data provisioning entities to autonomously and securely manage the tracking data related to a given object or set of objects.

Thereby, only the respective first relevant entity (for example, the manufacturer of the product) need be given the a priori right to initially create a tracking data set within the tracking system for the given object that is to be tracked. For this purpose, the manufacturer may log in to the tracking system, authenticate itself, and send the requested data.

Once a data set has been initialized for the object, the current owner of it can autonomously decide which entity (or entities) should be made responsible for further altering the data. Modifications will typically comprise the addition of new entries to the current (initial) data set.

For example, the manufacturer of a product may determine the next responsible entity, for example the wholesaler, after the wholesaler has ordered or paid for the given product. Depending on the granularity of the data to be collected, the intended next entity may also be the carrier company that transports the ordered product. After successful delivery and altering the tracking data, the carrier may designate the wholesaler as the next responsible entity to further manage the respective data sets.

In general, the “current owner” (with “owner” being understood to follow the broad definition given above) of the object may have access to the tracking data of that object. The current owner may further authorize the respective “next owner” to manage or alter the tracking data sets, typically after the object has changed its owner or other context that may be relevant for tracking.

Thereby, the current owner can either completely or partly lose its rights to make further changes on the data.

It is also possible to handle access to tracking data of complex objects (e.g. cars) which contain multiple objects (e.g. gears, tires, engine, etc.) that can be tracked either as a set of single objects or even as one cumulated entity.

The embodiments of the present invention also support the (special) case where the current owner of the object and the related tracking data can authorize multiple next owners (i.e. the successors of successors etc.) instead of authorizing exactly one next entity.

This case is especially relevant for serving more stable/static supply chains or static parts of dynamic/ad-hoc supply chains.

In such cases, the current owner (who might dominate the complete supply chain) determines the way which the object should go trough until a certain point of time or location. For example, the manufacturer of a product exactly plans the way of the product through the supply chain, via the entities A, B and C in that sequence. Accordingly, the manufacturer can authorize A, B and C to make changes on the respective tracking data related to the product.

Security of messages that are sent to the tracking system's authorization service is another concern that is addressed by embodiments of the present invention. The messages are preferably authenticated, in order to ensure the identity of the access granting entity, i.e. the current object owner. The messages are preferably protected against malicious changes by unauthorized parties who could otherwise gain access to the sensitive data, for instance, by granting access themselves. The messages may also be protected against eavesdropping, in order to protect against unauthorized parties that otherwise could monitor the process within the supply chain and/or make copies of the sent authorization messages.

In additional embodiments, the above security protections may also be applied to the respective tracking information submitted to the tracking system.

To fulfill the above security protections, embodiments of the present invention may implement one of a number of security methods. Such methods include password based authentication methods and digital signatures; message integrity codes, such as cryptographic hash functions or keyed message authentication codes; and message encryption algorithms.

Depending on the selected security technologies, the access control service might be coupled with the corresponding security systems, such as public key infrastructures (i.e. when digital signatures are used to authenticate messages), password management and validation services, etc. These systems can be either run by the operator of the tracking system, or by a trusted external security service provider.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims. The terms and expressions that have been employed here are used to describe the various embodiments and examples. These terms and expressions are not to be construed as excluding equivalents of the features shown and described, or portions thereof, it being recognized that various modifications are possible within the scope of the appended claims.

What is claimed is:

1. A computer-implemented method of managing product tracking data for tracking products in a supply chain, said method comprising the steps of:
authorizing access to a database by a first entity;
accessing, by said first entity, a data record in said database, wherein said data record is associated with a product to be tracked in said supply chain;
associating, by said first entity, said data record with a second entity, wherein said second entity corresponds to an entity in said supply chain that will assume control over said product subsequent to said first entity;
authorizing access to said database by said second entity;
accessing, by said second entity, said data record in said database.

2. The method of claim 1, further comprising:
authorizing no access to said database by said first entity, after said data record has been associated with said second entity.

3. The method of claim 1, further comprising:
authorizing partial access to said database by said first entity, after said data record has been associated with said second entity.

4. The method of claim 1, wherein said product to be tracked in said supply chain comprises an aggregation of associated products.

5. The method of claim 1, wherein said step of accessing, by said first entity, comprises at least one of creating said data record, reading said data record, altering said data record, updating said data record, copying said data record, and deleting said data record.

6. The method of claim 1, wherein said second entity comprises a plurality of second entities.

7. The method of claim 1, wherein said step of accessing, by said second entity, comprises at least one of reading said data record, altering said data record, copying said data record, and updating said data record.

8. The method of claim 1, further comprising:
associating, by said second entity, said data record with a third entity, wherein said third entity corresponds to another entity in said supply chain that will assume control over said product subsequent to said second entity.

9. The method of claim 1, wherein said step of accessing, by said second entity, comprises creating a second data record associated with a second product to be tracked in said supply chain, wherein said product comprises a first product, wherein said data record comprises a first data record, wherein said second product includes said first product, and wherein said second data record includes a pointer to said first data record.

10. A system including software for managing product tracking data for tracking products in a supply chain, said software comprising:
a first component that stores a data record, wherein said data record corresponds to a product to be tracked in said supply chain;
a second component that manages access to said data record by a first entity and a second entity in said supply chain, wherein said first entity associates said data record with said second entity, and wherein said second entity corresponds to an entity in said supply chain that will assume control over said product subsequent to said first entity.

11. The system of claim 10, wherein said second component further manages access to said data record by authorizing no access to said database by said first entity, after said data record has been associated with said second entity.

12. The system of claim 10, wherein said second component further manages access to said data record by authorizing partial access to said database by said first entity, after said data record has been associated with said second entity.

13. The system of claim 10, wherein said second entity associates said data record with a third entity, wherein said third entity corresponds to yet another entity in said supply chain that will assume control over said product subsequent to said second entity.

14. The system of claim 10, wherein said second entity creates a second data record associated with a second product to be tracked in said supply chain, wherein said first component stores said second data record, wherein said product comprises a first product, wherein said data record comprises a first data record, wherein said second product includes said first product, and wherein said second data record includes a pointer to said first data record.

15. A system including software for managing product tracking data for tracking products in a supply chain, said software comprising:
a tracking database that stores a tracking record, wherein said tracking record corresponds to a product to be tracked in said supply chain;
an access rights database that stores an access record, wherein said access record is associated with said tracking record; and
a tracking application that manages access to said tracking record by a first entity and a second entity in said supply chain using said access record, wherein said first entity associates said access record with said second entity, and wherein said second entity corresponds to an entity in said supply chain that will assume control over said product subsequent to said first entity.

16. The system of claim 15, wherein said tracking application further manages access to said tracking record by authorizing no access to said database by said first entity, after said access record has been associated with said second entity.

17. The system of claim 15, wherein said tracking application further manages access to said tracking record by authorizing partial access to said database by said first entity, after said access record has been associated with said second entity.

18. The system of claim 15, wherein said tracking application further manages access to said access record by said second entity, wherein said second entity associates said access record with a third entity, wherein said third entity corresponds to yet another entity in said supply chain that will assume control over said product subsequent to said second entity.

19. The system of claim 15, wherein said tracking application further manages access by said second entity to create a second tracking record associated with a second product to be tracked in said supply chain, wherein said tracking database stores said second tracking record, wherein said product comprises a first product, wherein said tracking record comprises a first tracking record, wherein said second product includes said first product, and wherein said second tracking record includes a pointer to said first tracking record.
